(19) United States
(12) Patent Application Publication
(10) Pub. No.: US 2006/0220814 A1
(43) Pub. Date: Oct. 5, 2006

(54) Tire pressure monitoring system and automatic tire repairing apparatus

(75) Inventor: Hidemitsu Kawashima, Kasugai (JP)

Correspondence Address: BEYER WEAVER & THOMAS, LLP, P.O. BOX 70250, OAKLAND, CA, 94612-0250, US

(73) Assignee: OMRON Corporation

(21) Appl. No.: 11/365,213

(22) Filed: Feb. 28, 2006

(30) Foreign Application Priority Data
Mar. 31, 2005 (JP) 2005-104623

(51) Int. Cl. B60C 23/02

(52) U.S. Cl. 340/442

(57) ABSTRACT

A tire pressure monitoring system transmits wireless signals from an on-vehicle controller to each of tires on a vehicle. Sensor units each measure pressure of the corresponding tire and transmit the measured pressure as a wireless signal. The controller transmits request signals to the sensor units at a specified timing and answer signals containing the measured pressure are returned. Each tire has a tank with a valve, containing a sealing agent. If the controller concludes from the measured pressure that there is a tire failure, a signal is transmitted and the corresponding sensor unit opens the valve to discharge the sealing agent into the interior of the tire to seal its failure. The controller may find a tire failure also based on the speed of change in the tire pressure calculated from the measured pressure even if the measured pressure is within a normal range.

Priority is claimed on Japanese Patent Application 2005-104623 filed Mar. 31, 2005.

### BACKGROUND OF THE INVENTION

This invention relates to a tire pressure monitoring system (TPMS) for a motor vehicle and to an automatic tire repairing apparatus having the function of automatically repairing tires.

Tire pressure monitoring systems are coming to be available as systems for monitoring the tire pressure of a motor vehicle. Such a system may comprise an on-vehicle controller adapted to transmit wireless signals through on-vehicle transmission antennas each provided near a corresponding one of the tires of the vehicle and sensor units each provided to one of the tires for measuring its pressure and transmitting the result of the measurement as a wireless signal. The on-vehicle transmission controller serves to transmit request signals at a specified timing from on-vehicle transmission antennas at specified parts to the sensor units of the corresponding tires. Each sensor unit, upon receiving this request signal, transmits an answer signal containing a measurement result back to the on-vehicle controller. Upon receiving this answer signal, the on-vehicle controller reads the measurement result and outputs an alarm if the measured tire pressure is abnormal.

Sealing agents for repairing a tire failure and seal pump-up devices for sealing a failed tire and also restoring the inner tire pressure back to an operable condition have been described, for example, in Japanese Patent Publications Tokkai 10-204219 and 9-118779. The former describes an assembly of a tire and a rim, containing in the inner cavity of the tire a device including a plastic tube for a sealing agent, a tool for opening this tube and injecting the sealing agent into the tire and a pressure sensor for detecting the lowering of the tire pressure to output a signal for causing this tool to open the tube.

Conventional tire pressure monitoring systems as described above are merely for reporting a lowered tire pressure condition to the vehicle user. In the case of a tire failure, the user is obliged to carry out a repair work, say, by changing the tire in order to continue using the vehicle. The assembly described in Japanese Patent Publications Tokkai 10-204219, on the other hand, does not serve to inform the user of the repair work which may have been carried out, and the user may remain unaware of the possible need to replace the repaired tire. With this device, furthermore, a gas is presumably discharged nearly at the same time as the sealing agent. This may allow the gas to escape before the damage to the tire is sufficiently sealed by the sealing agent. An example described therein is adapted to discharge the sealing agent when a reduction in pressure by 0.5 bars is detected. This means that the failure is not detected until the pressure drops by this much amount and the detection may be delayed.

### SUMMARY OF THE INVENTION

It is therefore an object of this invention to provide a tire pressure monitoring system (TPMS) for a vehicle provided with the function of automatically repairing a tire failure.

Another object of this invention is to provide a TPMS and an automatic tire repairing apparatus with an automatic tire repairing function, capable of detecting a tire failure at an early stage and carrying out its repair.

A tire pressure monitoring system according to this invention may be characterized as comprising an on-vehicle controller adapted to transmit wireless signals to tires on the vehicle and sensor units each provided to a corresponding one of the tires and each adapted to measure pressure of the corresponding tire and to transmit the measured pressure as a wireless signal. In the above, the on-vehicle controller is adapted to transmit request signals to the sensor units at a specified timing and the sensor units are each adapted to transmit to the on-vehicle controller an answer signal containing the measured pressure upon receiving the request signal. Each of the tires is provided with a tank (resin tank) and a valve (resin valve), the resin tank containing a resin material capable of sealing a tire failure by being discharged into the tire, the resin valve being adapted to open and close the resin tank to the interior of the tire by a control by corresponding one of the sensor units. The on-vehicle controller is adapted to judge from the measured pressure transmitted from the corresponding sensor unit whether the corresponding tire has a failure and to transmit a resin-discharging signal for opening the resin valve to the corresponding sensor unit of the corresponding tire if it is judged that the corresponding tire has a failure. The sensor units are each adapted to open the resin valve of the corresponding tire to discharge the resin material from the corresponding resin tank into the interior of the corresponding tire if the resin-discharging signal is received.

In the above, the mode of “discharging” into the interior of a tire may be either as a stream or as a jet. The “request signal” need not necessarily include data requiring a response from the sensor unit. It is sufficient if it serves to cause the sensor unit to return an answer signal. For example, a so-called wake-up signal for activating a sensor unit in the stand-by condition in an energy-saving mode may serve as the request signal. “Vehicle” is not limited to ordinary motor vehicles such as four-wheelers and two-wheelers but also any equivalent vehicles such as small airplanes because they have landing wheels and hence make the present invention applicable.

With a tire pressure monitoring system of this invention, an on-vehicle controller judges the occurrence of a tire failure based on the result of pressure measurement contained in an answer signal. If it is judged that there is a tire failure, a (resin-discharging) signal is transmitted from the on-vehicle controller to the sensor unit of the corresponding tire and the sensor unit which receives this signal opens the electromagnetic valve of the corresponding tire to cause the resin material (serving as a sealing agent) from the corresponding (resin) tank. Thus, the failed tank is repaired automatically to become usable while the on-vehicle controller outputs an alarm. Thus, the user is informed not only that there was a tire failure but also which tire had the failure and that the failure has been repaired (that is, the vehicle can still run but the tire should be replaced sometimes soon).

A tire pressure monitoring system according to a preferred embodiment of the invention may be characterized in that each of the tires is further provided with a gas tank filled with a compressed gas and a gas valve adapted to open and close this gas tank to the interior of the corresponding tire by a control by the corresponding sensor unit, that the on-vehicle controller is adapted to judge whether or not discharging of the resin material has been completed and, if it is judged to have been completed, to transmit a gas-discharging signal through an on-vehicle antenna to the corresponding sensor unit of the corresponding tire to open the gas value, and that the sensor unit is each adapted to open the gas valve of the corresponding tire upon receiving the gas-discharging signal, to discharge the gas from the corresponding gas tank into the interior of the corresponding tire.

Thus, not only is the failed tire automatically repaired and may become usable again nearly as normally but the user is also made aware that such a temporary repair has been carried out. Another merit of this invention is that the pressure condition of the failed tire can be repaired more dependably because the compressed gas is discharged after the discharge of the resin and hence after the failed tire is more sufficiently sealed with the resin material.

A tire pressure monitoring system according to still another preferred embodiment may be characterized in that the on-vehicle controller is adapted to judge whether or not the corresponding tire has a failure based on the speed of change in the tire pressure calculated from the measured pressure even if the measured pressure is within a normal range. In the above, the speed of change in the tire pressure may be measured as the change per unit time or as the pressure differential. According to this embodiment of the invention, an abnormal condition of a tire can be detected at an early stage for an automatic repairing.

An automatic tire repairing apparatus of this invention is set inside a tire of a vehicle and adapted to automatically repair a failure of this tire. It may be characterized as comprising a controller, a pressure sensor for measuring pressure of the tire, a tank (“resin tank”) containing a resin material for being discharged into the interior of the tire to seal and repair a failure of the tire and a valve (“resin valve”) for opening and closing the resin tank to the interior of the tire by a control by the controller wherein the controller is adapted to judge whether or not the tire has a failure based on a pressure value calculated from measured pressure by the pressure sensor, to open the resin valve to cause the resin material to be discharged from the resin tank into the interior of the resin tank if it is judged that the tire has a failure, and to judge whether or not the tire has a failure based on the speed of change in the tire pressure calculated from the measured pressure even if the measured pressure is within a normal range.

With an apparatus of this invention thus structured, a tire failure is detected by the controller set inside the tire based on the result of measurement by a pressure sensor inside the tire and if it is judged that there is a tire failure, the resin valve set inside the tire is opened to cause the resin material inside the resin tank inside the tire to be discharged. Thus, a tire failure is automatically repaired and the tire becomes usable again. Since no controller is required on the side of a vehicle and no communication means with the vehicle is necessary, the tire can be repaired independently of the vehicle. In this case too, since the judgment is made on the basis of the speed of change in the tire pressure, the failure can be detected at an earlier stage for an automatic repairing.

An automatic tire repairing apparatus according to a preferred embodiment of the invention may be characterized as further comprising a gas tank filled with a compressed gas and a gas valve adapted to open and close the gas tank to the interior of the tire by a control by the controller wherein the controller is further adapted to judge whether or not discharging of the resin material has been completed and, if it is judged to have been completed, to open the gas value and to discharge the gas from the gas tank into the interior of the tire.

In this case, too, not only is the failed tire automatically repaired and may become usable again nearly as normally but the user is also made aware that such a temporary repair has been carried out. Another merit of this invention is that the pressure condition of the failed tire can be repaired more dependably because the compressed gas is discharged after the discharge of the resin and hence after the failed tire is more sufficiently sealed with the resin material.

### BRIEF DESCRIPTION OF THE DRAWINGS

FIG. 1 is a block diagram of a tire pressure monitoring system embodying this invention.

FIG. 2 is a drawing for showing how principal components of the system of FIG. 1 are distributed on a vehicle of a kind with four wheels.

FIG. 3A is a sectional view of an annular tube that forms a resin tank and a gas tank, FIG. 3B is a drawing for showing how it is attached, and FIG. 3C shows its hinged structure for the attachment.

FIGS. 4, 5 and 6 show a flowchart of the operations by the controllers.

### DETAILED DESCRIPTION OF THE INVENTION

The invention is described next with reference to the drawings.

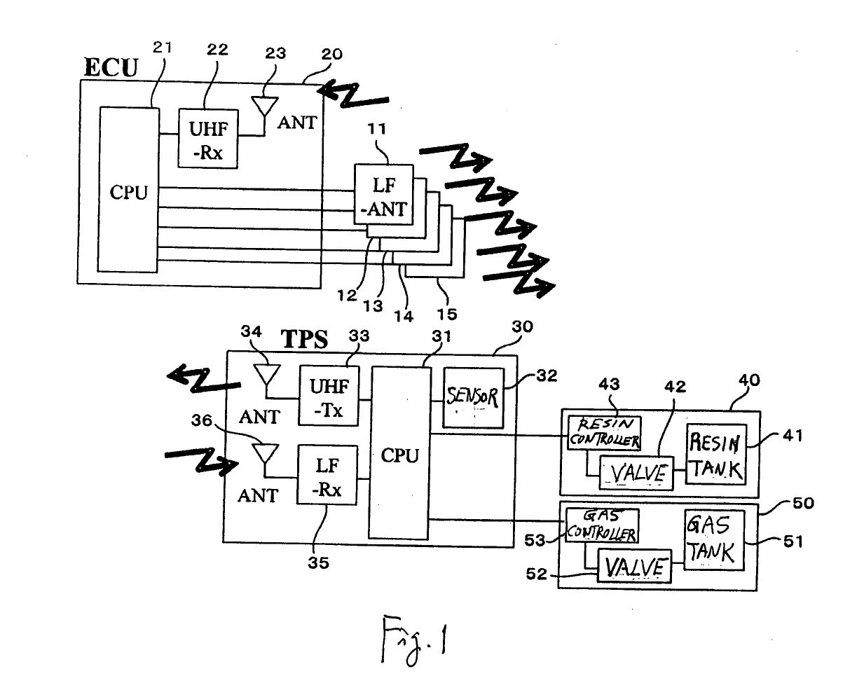

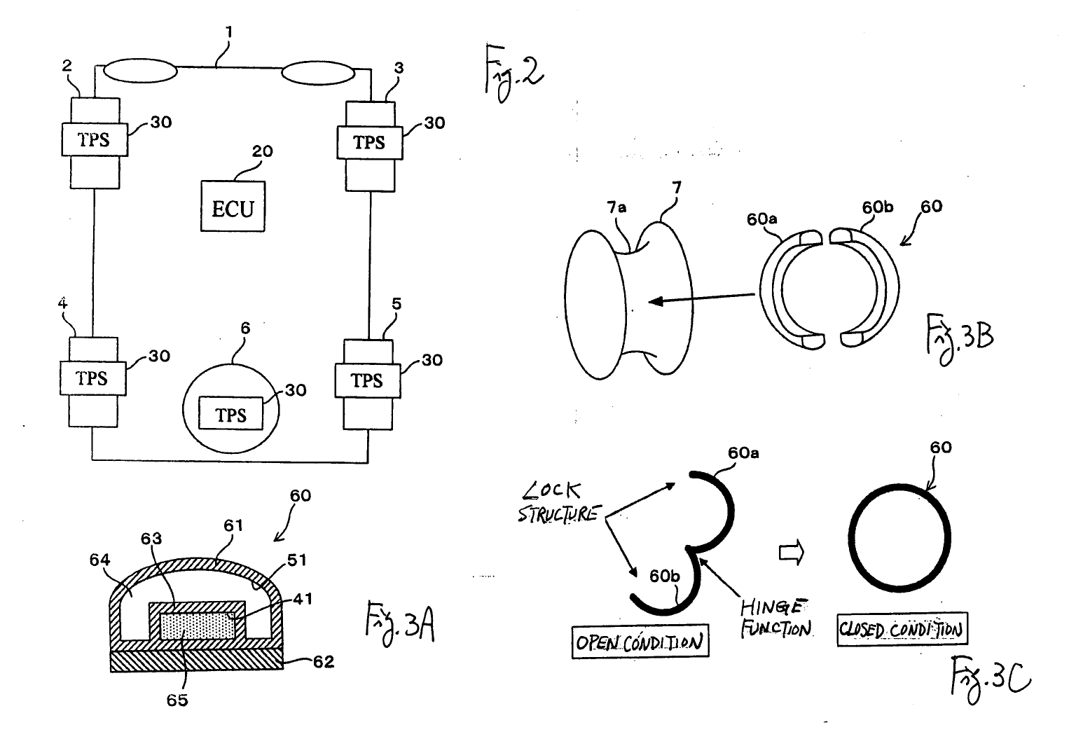

FIG. 1 is a block diagram for explaining the structure of a tire pressure monitoring system embodying this invention. FIG. 2 is for showing how its principal components are distributed on a vehicle 1 of a kind with four wheels.

As shown in FIG. 1, the vehicle 1 is provided with a tire pressure monitoring system including on-vehicle transmission antennas 11-15, an on-vehicle controller (ECU) 20, sensor units (TPS) 30, a resin discharger 40 and a gas discharger 50. Each of the on-vehicle transmission antennas 11-15 is disposed near a corresponding one of the tires (shown at 2-6 in FIG. 2 inclusive of a spare tire 6) such as near the tire housings and at a lower portion of the trunk storing the spare tire 6 and is adapted to transmit a request signal (of LF waves) to a corresponding one of the sensor units 30 under the control of the on-vehicle controller 20.

The on-vehicle controller 20 is a main controller of the TPMS set inside a specified control box inside the body of the vehicle and includes a control circuit 21 comprised of a microcomputer, communication circuits for wireless signals (such as a transmission circuit for LF waves and a reception circuit for UHF waves) and a reception antenna 23 for UHF waves. Although an example is shown where the control circuit 21 is functioning as the transmission circuit for LF waves, a transmission circuit for LF waves may be provided separately from the control circuit 21.

The on-vehicle controller 20 is for carrying out basic control processes such as sequentially carrying out the pressure monitoring processes of the individual tires (to be described in detail below) in a periodic manner and outputting an alarm (by sound, light and/or character display) if, for example, there is a tire with the pressure not within a normal range, to inform the driver of the position of the tire and its abnormal condition.

The on-vehicle controller 20 is further adapted to judge whether or not there is a tire failure and, if a judgment of tire failure is made, to output a valve-opening signal (to be described below) from the corresponding one of the on-vehicle transmission antennas 11-15 to the sensor unit 30 of the corresponding tire for opening an electromagnetic valve 42 for a resin material (to be described below).

The control circuit 21 of this on-vehicle controller 20 is activated, for example, only under a condition where the monitoring of tire pressure is necessary (such as when the engine is operating) such that the power consumption can be minimized.

The sensor units 30 are each set inside a tire such as at the position of its valve and each include a control circuit 31 (say, comprising a microcomputer), a pressure sensor 32 for measuring the pressure of a tire, a transmission circuit 33 for transmitting the pressure data measured by this sensor 32 as a wireless signal (UHF waves), a transmission antenna 34, a reception circuit 35 and a reception antenna 36 for receiving the aforementioned request signal.

The control circuit 31 of the sensor unit 30 is usually in the energy-saving stand-by condition and is activated into the normal operating mode from this stand-by mode whenever it becomes necessary. This control circuit 31 is also adapted, when the aforementioned valve-opening signal is received, to open the electromagnetic valve 42 (to be described below) of the corresponding tire to discharge the aforementioned resin material from a corresponding resin tank into this tire.

The resin discharger 40 is provided with a tank (the “resin tank 41) filled with a resin material (shown at 65 in FIG. 3A) adapted to be discharged (as a stream or as a jet) into the tire so as to seal its damaged part, the aforementioned electromagnetic valve (or the “resin valve” 42) for opening and closing this resin tank 41 to the interior of the tire and a resin controller 43 for opening and closing the resin valve 42 according to a command from the control circuit 31 of the sensor unit 30. In the above, the resin controller 43 may be eliminated, with the control circuit 31 of the sensor unit 30 serving to directly control the resin valve 42.

The gas discharger 50 is provided with a tank (the “gas tank” 51) filled with a compressed inactive gas such as nitrogen (shown at 64 in FIG. 3A), another electromagnetic valve (or the “gas valve” 52) for opening and closing this gas tank 51 to the interior of the tire and a gas controller 53 for opening and closing this gas valve 52 according to a command from the control circuit 31 of the sensor unit 30. In the above, the gas controller 53 may be eliminated, with the control circuit 31 of the sensor unit 30 serving to directly control the gas valve 52.

The aforementioned resin tank 41 and gas tank 51 may be formed in the form of an annular tube 60 as shown in FIGS. 3A, 3B and 3C, attached to a tire by being wound around the sunken part (well part) 7a of the outer periphery of its wheel (rim) 7. After this annular tube 60 is wound uniformly and entirely around the wheel 7, the wheel can be balanced by the usual method of adjustment by means of a weight on the side surface.

It is convenient to structure this annular tube 60 in the form of two semi-circular pieces 60a and 60b, as shown in FIG. 3C connected together by a hinge (not shown) or a hinge-like structure such that they can be opened when they are placed around the wheel 7 and closed thereafter. A lock or a lock-like component (not shown) may be further provided to keep the pieces in the closed form and prevented from falling off.

FIG. 3A shows the cross-sectional structure of this annular tube 60, comprising its main body 61 formed by injection molding of a synthetic resin material with high heat-resistance for the high-speed travel of the vehicle and a sheet 62 which is fastened to the internal surface of the main body 61 in any way such as glueing, welding and cladding. A partition wall 63 is formed inside the main body 61 so as to divide its interior into two parts. The outer space becomes the gas tank 51 and the inner space functions as the resin tank 41. The aforementioned compressed gas 64 is sealed inside the gas tank 51 and the resin material 65 as the sealing agent is filled inside the space serving as the resin tank 41.

As for the resin material 65, the kinds of sealing agents described in aforementioned Japanese Patent Publications Tokkai 10-204219 and 9-118779 may be used. In general, a material with sufficient fluidity and of the type that dries quickly in air is preferred. The aforementioned sheet 62 may be of a sponge-like substance adapted to softly fit with the attachment surface on the outer periphery of the wheel 7. Such a material serves to attach the tube 60 tightly to the wheel 7 and also to prevent the generation of vibrations and noise when the vehicle is running.

There is explained next the pressure monitoring process to be carried out by the control circuit 21 of the on-vehicle controller 20 periodically on each of the tires after it is activated. This pressure monitoring process starts by judging whether it is the time for a specified detection. The detection timing means the time for obtaining the pressure value of the target tire to be examined. This is carried out, for example, in a set sequence firstly for the left-front tire, secondly for the right front tire, thirdly for the left rear tire, fourthly for the right rear tire and lastly for the spare tire. When it is the time for measuring the pressure in any of these tires, the next step of transmitting a request signal is carried out. If it is not the time yet, the process is stopped.

In the step of transmitting a request signal, a specified request signal is transmitted from the on-vehicle transmission antenna corresponding to the target tire for the detection. After the step of transmitting a request signal, it is judged in the subsequent signal-reception step whether a normal answer signal is received or not within a specified wait period. Explained more in detail, it is examined whether or not a signal containing at a specified position a code matching an ID code which is particular to the vehicle and preliminarily stored is received or not through the reception antenna 23. If such a normal answer signal is received within a specified wait period, the process proceeds to the next data-reading step. An alarm signal is outputted if the aforementioned wait period passes without any normal answer signal being received.

In the next data-reading step, the measured data on the pressure contained in the received answer signal are read out and it is determined whether the obtained data are normal or not (that is, whether the measured pressure is within an appropriate range). If it is found to be normal, the process is completed. If it is not found to be normal, an abnormality-reporting step is executed. The determination of whether the detected pressure is normal or not may include the determination of whether the detected pressure is too high or too low. Even if the tire pressure is found to be within a normal range, it may be adapted to judge whether the pressure is tending to become low such that it is desirable to put in more air.

The abnormality-reporting step may include outputting an alarm (by sound, light or a character display) indicative of the abnormal condition of the tire pressure (or, as explained above, the condition of the pressure tending to become low or directly the pressure value itself). If a normal answer signal fails to be received in the signal reception step, an alarm of a different kind may be outputted to indicate the failure of communication with the sensor unit of the target tire.

Next, the process by the control circuit 31 of the sensor unit 30 for transmitting pressure data will be explained. If a signal with a specified frequency and with intensity above a specified level (before demodulation) corresponding to the request signal is received, the process proceeds to the normal mode and a reception process for this signal is carried out to determine whether this signal is a normal request signal. Explained more in detail, the received signal (a binary data array after demodulation) is analyzed to determine whether or not the same data as the preliminarily stored particular ID code of the vehicle are included at the specified part (such as the ID part) of the received signal and it is judged to be a normal request signal if the result of the determination is affirmative.

If the received signal is judged to be a normal request signal by the process described above, an answer signal comprised of the aforementioned ID code and the newest pressure data on the tire is transmitted for a specified number of times. If the received signal is not judged to be a normal request signal by this process, or after the aforementioned transmission of the answer signal is completed, the process goes back to the stand-by mode and waits for the input of the next signal.

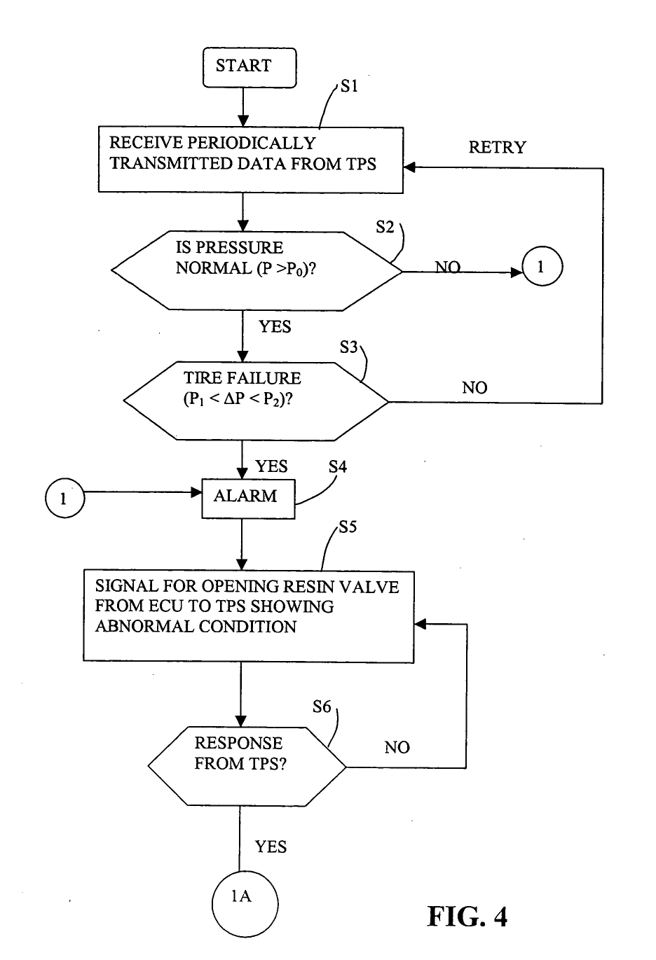

Next, the flowchart of FIGS. 4, 5 and 6 is referenced to explain the characteristic operations of the system according to this invention such as the characteristic controls by the control circuits 21 and 31 of the controllers 20 and 30.

Whenever periodically transmitted data from one of the sensor units 30 (that is, the pressure data contained in the answer signals transmitted by the aforementioned pressure data transmission process) are received (Step 1), the control circuit 21 of the on-vehicle controller 20 carries out Step S2 and the following steps (except Steps S7-S9) on the tire corresponding to that sensor unit.

In Step S2, it is determined whether or not this pressure value (P) is within a normal range, or whether or not it is greater than a specified threshold value P₀ which is selected to be an allowable minimum value such that the tire may be regarded to have a failure if its pressure is less than this minimum value. If the pressure value P is found to be less than this threshold value P₀ (NO in Step S2), the control circuit 21 carries out an alarm-outputting process to output an alarm (by sound, light and/or a character display) to indicate that the target tire being inspected has a failure (Step S4).

The control system may be alternatively so structured that, if the tire pressure is found to be outside the normal range in Step S2, an alarm is outputted but Steps S5 and thereafter are not carried out. This is because there are situations where there is no tire failure of the type that is for an automatic repairing although the pressure is determined to be outside the normal range.

If the pressure value P is found to be normal (YES in Step S2), the control circuit 21 undertakes to judge whether or not the target tire under investigation has a failure based on the speed of change in the tire pressure (Step S3), or the change in the pressure value within a unit time interval or the pressure differential. Explained more in detail, this may be done by calculating the change in the pressure value of the tire of which the pressure value P has just been obtained from the pressure value of the same tire obtained previously and examining whether the absolute value of this change, or the differential ΔP, is greater than a predetermined minimum value P₁ but less than a predetermined maximum value P₂. If the differential ΔP is found to be within this range (YES in Step S3), it is concluded that this target tire has a failure to be automatically repaired, and the process proceeds to Step S4. If the differential ΔP is found to be outside this range (NO in Step S3), it is concluded that the failure is not an type to be subjected to the automatic repair process and the process is returned to Step S1.

In the above, the minimum value P₁ is for the purpose of excluding tires with a slow leak from the kind to be automatically repaired. Thus, its value may be selected as the maximum of the slow-leak situations that occur frequently. The maximum value P₂ is for excluding situations of abnormal pressure changes other than normal tire failures suited for automatic repairing such as situations of a burst. Thus, its value may be selected as the maximum pressure change that can appropriately be repaired by the sealing agent.

In Step S5, the control circuit 21 transmits from the corresponding on-vehicle transmission antenna to the sensor unit 30 of the corresponding tire a signal for opening the electromagnetic valve 42 for the resin tank 41. As this valve-opening signal is received, the control circuit 31 of the corresponding sensor unit 30 is activated, if necessary, to open the electromagnetic valve 42 to cause the resin material 65 from the resin tank 41 into the interior of the corresponding tire. A response signal is returned to the on-vehicle controller 20 to the effect that the aforementioned valve-opening signal has been received thereby. Next, the on-vehicle controller 20 checks whether or not this response signal has been received by the control circuit 21 from the sensor unit 30 (Step S6). If there is no reception (NO in Step S6), Step S5 is repeated. If it is received (YES in Step S6), the controller 20 carries out Step S10.

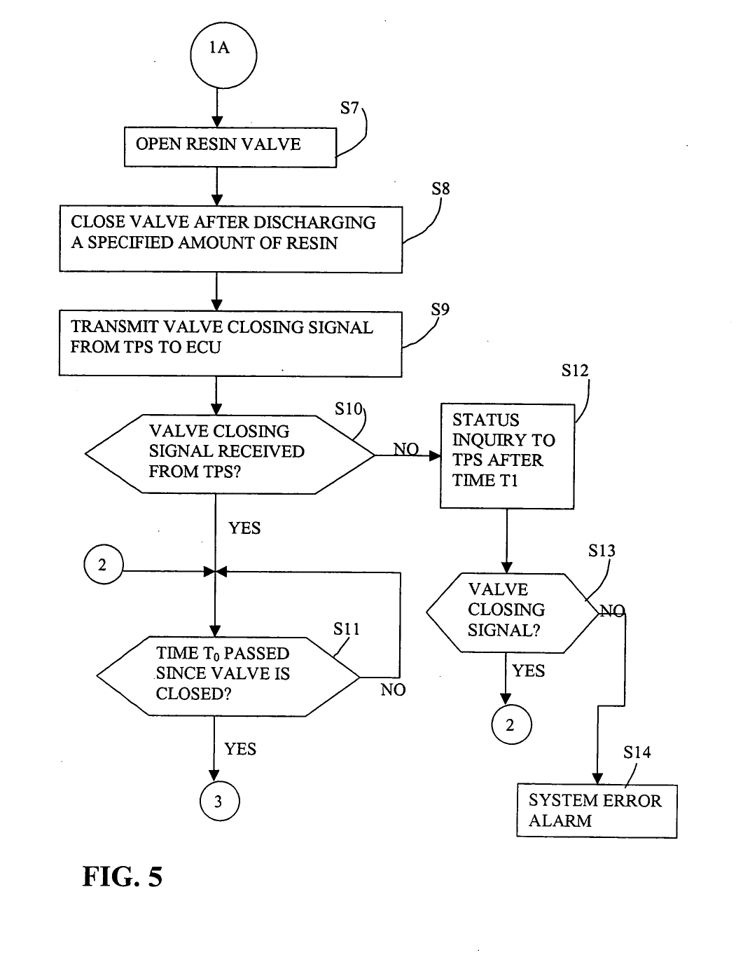

Steps S7-S9 in FIG. 5 are steps carried out by the sensor unit 30 by the control of the control circuit 31 according to the control by the control circuit 21 in Step S5. In Step S7, the resin material 65 is discharged from the resin tank 41 into the tire corresponding to the control circuit 31 of the sensor unit 30. Since the discharged resin material 65 has sufficient fluidity, it spreads quickly throughout the tire by the centrifugal force as the tire rotates. After a specified quantity of the resin material 65 has been discharged or after the electromagnetic valve 42 is left open for a specified length of time, the electromagnetic valve 42 is closed (Step S8) and a signal informing this closing is communicated to the on-vehicle controller 20 (Step S9).

In Step S10 thereafter, the control circuit 21 determines whether or not the signal about the closing of the valve has been received from the corresponding sensor unit 30. If this valve-closing signal is found to have been received (YES in Step S10), Step S11 is carried out. If the valve-closing signal has not been received (NO in Step S10), Step S12 is carried out. In Step S11, the control circuit 21 determines whether or not a specified length of time T₀ (such as a few minutes) has passed since the valve-closing signal was received. Step S11 is repeated until time T₀ is found to have passed (YES in Step S11) and then Step S15 is carried out. In Step S12, the control circuit 21 waits until another specified length of time T₁ (such as a few minutes) passes, then transmits a status inquiry signal to the corresponding sensor unit 30 to inquire its status and thereafter carries out Step S13.

Upon receiving this status inquiry signal, the control circuit 31 of the sensor unit 30 is activated, if necessary, and transmits the valve-closing signal again if the electromagnetic valve 42 has indeed been closed. In Step S13, the control circuit 21 determines once again whether or not the valve-closing signal was received. If it has been received (YES in Step S13), the process returns to Step 12. If it has not (No in Step S13), an alarm is outputted (by sound, light and/or a character display) on the system error (Step S14) to complete the process.

After Step S11, although it is not shown in FIG. 5, steps of measuring pressure and calculating its change ΔP again may be inserted in order to make certain that the tire has been fixed and the leakage of gas has stopped.

Next, the control circuit 21 transmits a gas discharge signal to the sensor unit 30 of the corresponding tire from the corresponding on-vehicle antenna for opening the corresponding electromagnetic valve 52 (gas valve). Upon receiving this gas discharge signal, the control circuit 31 of the sensor unit 30 is activated, if necessary, to open the corresponding electromagnetic valve 52 to discharge the gas 64 from the corresponding gas tank 51 into the interior of the corresponding tire. At the same time, a response signal is returned to the on-vehicle controller 20 to inform that the gas discharge signal has been received thereby.

Thereafter, if the control circuit 21 judges that the response signal from the sensor unit 30 has been received (YES in Step S16), it proceeds to carry out Step S18. If otherwise, the process of Step S15 is repeated.

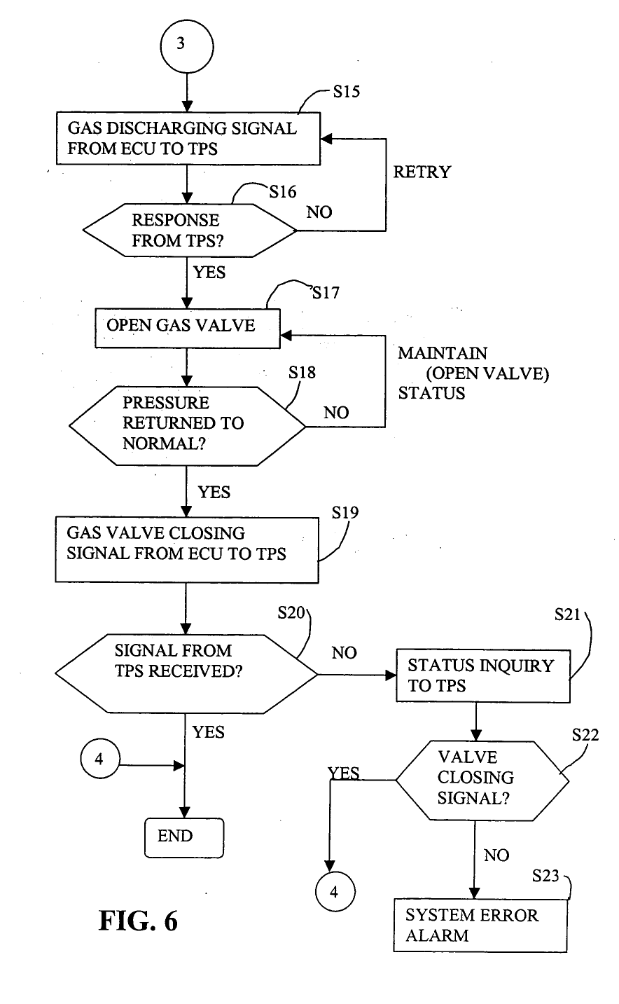

Step S17 of FIG. 6 is a process carried out by the control circuit 31 of the sensor unit 30 according to Step S15 of the control circuit 21, or the process by which the electromagnetic valve 52 of the corresponding tire is opened by the control circuit 31 of the sensor unit 30 to discharge the gas 64 from the corresponding gas tank 51. Since the discharged gas 64 is sufficiently compressed, the tire pressure is increased as a result.

Next in Step S18, the control circuit 21 receives the newest pressure data from the corresponding sensor unit 30 by the so-called “event communication” (non-synchronous communication in one direction), to be explained in detail below, and judges whether or not the pressure has returned to the normal range. If the pressure is judged to have returned to the normal range (YES in Step S18), the process proceeds to Step S19. If the event communication is not received or the newest pressure has not returned to the normal range (NO in Step S18), the gas valve 52 is kept open in status quo and Step S18 is repeated.

The control circuit 31 of the sensor unit 30 is adapted to be activated and to transmit a signal containing the newest pressure data even without receiving any request signal if there is a sudden change in the value detected by the pressure sensor 32 (or, the function of event transmission). The system may also be so arranged as to output an alarm as in Step S14 if the pressure does not return to the normal range after a specified length of time.

In Step S19, the control circuit 21 transmits a gas valve closing signal to the corresponding sensor unit 30 to close its electromagnetic gas valve 52 and then the process proceeds to Step S20. Upon receiving this gas valve closing signal, the control circuit 31 of the sensor unit 30 is activated, if necessary, to close the corresponding electromagnetic valve 52 and transmits a signal indicative of the closing of the gas valve 52 to the on-vehicle controller 20.

In Step S20, the control circuit 21 judges whether or not the signal from the corresponding sensor unit 30 has been received. If it has been received (YES in Step S20), the series of processes is completed. If otherwise (NO in Step S20), the control circuit 21 transmits a status inquiry signal to the corresponding sensor unit 30 (Step S21) and proceeds to Step S22. Upon receiving this status inquiry signal, the control circuit 31 of the sensor unit 30 is activated, if necessary, to transmit the signal once again if the valve 52 has been closed.

In Step S22, the control circuit 21 judges again whether or not the gas valve closing signal has been received from the corresponding sensor unit 30. If it has been received (YES in Step S22), the series of processes comes to an end. If otherwise (NO in Step S22), an alarm (by sound, light and/or a character array) for a system error is outputted (Step S23) before the processes are ended.

With a system embodying this invention as described above, request and answer signals are exchanged between the sensor unit 30 of each tire and the on-vehicle controller 20 at a specified detection timing, and an alarm is outputted if the on-vehicle controller 20 fails to receive an answer signal or the pressure data contained in an answer signal are abnormal such that the basic functions of a TPMS are carried out. Moreover, the on-vehicle controller 20 serves to judge whether or not there is an occurrence of a tire failure, based on the pressure data contained in answer signals and if it is judged that there is a tire failure, a signal for a repair is transmitted from the on-vehicle controller 20 to the corresponding sensor unit 30 of the corresponding tire such that the sensor unit 30, upon receiving this signal, serves to open the resin valve 42 to discharge the sealing agent into the failed tire. Thus, the tire failure is automatically repaired and the vehicle can continue to run. An alarm is also outputted to the on-vehicle controller 20 (Step S4) such that the user is made aware of the occurrence of the failure and which of the tires has been repaired.

According to the illustrated example, furthermore, air tanks filled with a compressed gas and valves for opening these tanks into the tires are provided. As soon as the discharge of the sealing agent is completed, the on-vehicle controller 20 receives a signal to this effect and serves to open the valve of the air tank for the corresponding tire such that compressed gas is discharged into the tire. Thus, the pressure inside the repaired tire is automatically corrected to a level close to the normal condition such that the vehicle can continue to run in a normal or nearly normal manner. Since the discharge of the compressed gas is effected after a specified time has elapsed and hence after the tire has been sufficiently repaired, the pressure condition inside the tire can be sufficiently restored to a normal level.

As explained above with reference to Steps S2 and S3 above, furthermore, the on-vehicle controller 20 may be adapted to detect a tire failure even if the measured pressure P by the pressure sensor 32 is within a normal range (or when P>P₀) if the change in pressure ΔP per unit time exceeds a certain value. Thus, an abnormal condition of a tire can be detected at an early stage to prepare for a repair.

It now goes without saying that the disclosed example above is not intended to limit the scope of the invention. Many modifications and variations are possible within the scope of the invention. For example, there need not be a one-to-one correspondence between the on-vehicle antennas and tires. A single antenna may be set both for the front and rear tires on one side of the vehicle.

The invention relates also to automatic tire repairing apparatus characterized as having the function of a tire pressure monitoring system (exclusive of the alarm-outputting function) described above with reference to FIGS. 1-6. Such apparatus need not necessarily be provided with the on-vehicle controller 20 or the on-vehicle antennas 11-15. The communication devices of the sensor unit 30 (such as the transmission circuit 33, the transmission antenna 34, the reception circuit 35 and the reception antenna 36) may also be dispensed with. Processes of judgment of a tire failure and automatic repair shown in FIGS. 4-6 (exclusive of those for alarm-outputting and wireless communications of Steps S4 and S14) may be carried out by the control circuit 31 of the sensor unit 30. In this case, the control circuit 31 serves as the controller of this invention. With an apparatus of this form, each single tire may be provided with an automatic repair function. It goes without saying, however, that the invention does not prevent the on-vehicle controller 20, the on-vehicle antennas 11-15 or the communication devices of the sensor unit 30 from being provided such that the determination of a tire failure by the sensor unit 30 can be communicated by a signal to the on-vehicle controller 20 for informing the user.

What is claimed is:

1. A tire pressure monitoring system comprising:
an on-vehicle controller adapted to transmit wireless signals to tires on a vehicle; and
sensor units each provided to a corresponding one of said tires and each adapted to measure pressure of the corresponding tire and to transmit the measured pressure as a wireless signal;
wherein said on-vehicle controller is adapted to transmit request signals to said sensor units at a specified timing and said sensor units are each adapted to transmit to said on-vehicle controller an answer signal containing the measured pressure upon receiving the request signal;
wherein each of said tires is provided with a resin tank and a resin valve, said resin tank containing a resin material capable of sealing a tire failure by being discharged into the tire, said resin valve being adapted to open and close said resin tank to the interior of said tire by a control by corresponding one of the sensor units;
wherein said on-vehicle controller is adapted to judge from the measured pressure transmitted from the corresponding sensor unit whether the corresponding tire has a failure and to transmit a resin-discharging signal for opening said resin valve to said corresponding sensor unit of said corresponding tire if it is judged that said corresponding tire has a failure; and
wherein said sensor units are each adapted to open the resin valve of the corresponding tire to discharge the resin material from the corresponding resin tank into the interior of said corresponding tire if said resin-discharging signal is received.

2. The tire pressure monitoring system of claim 1 wherein each of said tires is further provided with a gas tank filled with a compressed gas and a gas valve adapted to open and close said gas tank to the interior of the corresponding tire by a control by the corresponding sensor unit;
wherein said on-vehicle controller is adapted to judge whether or not discharging of said resin material has been completed and, if it is judged to have been completed, to transmit a gas-discharging signal through an on-vehicle antenna to the corresponding sensor unit of the corresponding tire to open the gas value; and
wherein said sensor unit is each adapted to open the gas valve of the corresponding tire upon receiving said gas-discharging signal, to discharge said gas from the corresponding gas tank into the interior of the corresponding tire.

3. The tire pressure monitoring system of claim 1 wherein said on-vehicle controller is adapted to judge whether or not the corresponding tire has a failure based on the speed of change in the tire pressure calculated from the measured pressure even if said measured pressure is within a normal range.

4. The tire pressure monitoring system of claim 2 wherein said on-vehicle controller is adapted to judge whether or not the corresponding tire has a failure based on the speed of change in the tire pressure calculated from the measured pressure even if said measured pressure is within a normal range.

5. An automatic tire repairing apparatus which is set inside a tire of a vehicle and adapted to automatically repair a failure of said tire, said automatic tire repairing apparatus comprising:
a controller;
a pressure sensor for measuring pressure of said tire;
a resin tank containing a resin material for being discharged into the interior of said tire to seal and repair a failure of said tire; and
a resin valve for opening and closing said resin tank to the interior of said tire by a control by said controller;
wherein said controller is adapted to judge whether or not said tire has a failure based on a pressure value calculated from measured pressure by said pressure sensor, to open said resin valve to cause said resin material to be discharged from said resin tank into the interior of said resin tank if it is judged that said tire has a failure, and to judge whether or not said tire has a failure based on the speed of change in the tire pressure calculated from the measured pressure even if said measured pressure is within a normal range.

6. The automatic tire repairing apparatus of claim 5 further comprising:
a gas tank filled with a compressed gas; and
a gas valve adapted to open and close said gas tank to the interior of the tire by a control by the controller;
wherein said controller is further adapted to judge whether or not discharging of said resin material has been completed and, if it is judged to have been completed, to open the gas value and to discharge said gas from said gas tank into the interior of said tire.
